(19) United States
(12) Patent Application Publication
(10) Pub. No.: US 2021/0389688 A1
(43) Pub. Date: Dec. 16, 2021

(54) NEGATIVE-CHARGING TONER

(71) Applicant: CANON KABUSHIKI KAISHA, Tokyo (JP)

(72) Inventors: Takaho Shibata, Tokyo (JP); Ryuji Murayama, Chiba (JP); Ryuichiro Matsuo, lbaraki (JP); Yuto Onozaki, Saitama (JP); Kenta Mitsuiki, lbaraki (JP); Megumi Shino, Chiba (JP); Hironori Minagawa, lbaraki (JP)

(21) Appl. No.: 17/336,397

(22) Filed: Jun. 2, 2021

(30) Foreign Application Priority Data
Jun. 11, 2020 (JP) 2020-101439

(51) Int. Cl. G03G 9/097; G03G 9/08; G03G 9/087

(52) U.S. Cl. CPC G03G 9/09775; G03G 9/08755; G03G 9/0825; G03G 9/0819

(57) ABSTRACT

A negative-charging toner comprising a toner particle comprising a binder resin and an organic-inorganic composite fine particle comprising resin fine particles and inorganic fine particles A, wherein the organic-inorganic composite fine particle is negative charging, the organic-inorganic composite fine particle has a structure in which at least a part of the inorganic fine particle A is embedded in the resin fine particle, a number average particle diameter Db of the organic-inorganic composite fine particle is 50 to 350 nm, and a plurality of convex portions derived from the inorganic fine particles A are present on the surface of the organic-inorganic composite fine particle.

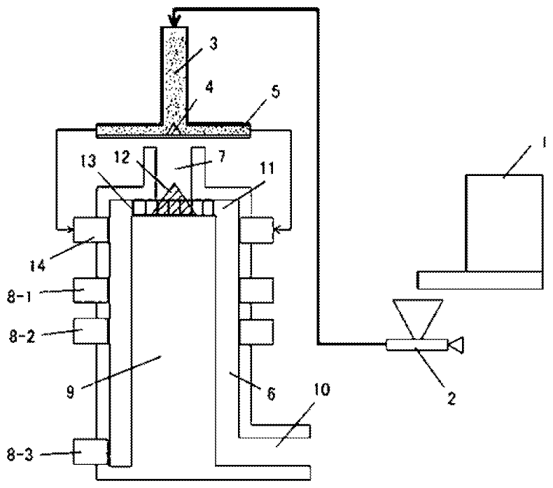

### BACKGROUND OF THE INVENTION

### Field of the Invention

The present disclosure relates to a negative-charging toner for use in an electrophotographic method, an electrostatic recording method, an electrostatic printing method, and the like.

### Description of the Related Art

In the electrophotographic method, an electrostatic charge image is formed as image information on the surface of an image bearing member through a charging step and an exposure step. Then, a toner image is formed on the electrostatically charged image with a charged toner (development step), the toner image is transferred to a recording medium (transfer step), and then the toner image is fixed on the recording medium. Through these steps, the image information is used as an output to form an image. Then, before a toner image is formed again, the toner that could not be transferred in the transfer step is cleaned with a blade or the like (cleaning step), so that image formation faithful to the image information can be continuously performed.

In recent years, with the widespread use of electrophotographic full-color copiers, not only higher speed and higher image quality, but also improvement of energy saving performance and additional performance, such as maintenance cost reduction, are required.

As a concrete measure to improve image quality further, a toner with a small particle diameter is required to improve dot reproducibility. However, when the particle diameter of the toner is reduced, the toner easily slips through in the cleaning step. Where the toner easily slips through, melt adhesion of the toner may be caused on the image bearing member by the heat generated by rubbing between the cleaning blade and the image bearing member. In particular, the higher the speed, the larger the amount of heat generated, hence, image defects derived from the toner melt-adhesion product formed on the image bearing member are likely to occur.

As a method for preventing a toner from slipping through in the cleaning step, Japanese Patent Application Publication No. 2017-198917 proposes using a toner in which specific inorganic fine particles are externally added to a toner particle.

Further, Japanese Patent Application Publication No. 2014-66784 proposes using a toner obtained by externally adding metal soap particles to a toner particle as a method for improving the cleaning performance.

### SUMMARY OF THE INVENTION

The present inventors examined the toner described in Japanese Patent Application Publication No. 2017-198917 and found the followings.

In an image forming apparatus using the toner described in Japanese Patent Application Publication No. 2017-198917, in the cleaning step, the inorganic fine particles separated from the toner particle can aggregate in the vicinity of the cleaning blade to form an inorganic fine particle layer formed from the inorganic fine particles. As a result, there is a certain distance between a segment, where heat is generated by the rubbing between the cleaning blade and the image bearing member, and the toner blocked by the cleaning blade, hence, the melt deformation of the toner can be suppressed and the toner can be prevented from slipping through.

However, when, after same image (e.g., a non-full-scale solid image) continuous formation, a halftone image different from the same image is formed, then, image defects with a difference in density between an image portion and a non-image portion in the same image may be formed on the halftone image. The present inventors consider the reason for this as follows.

Since the inorganic fine particles described in Japanese Patent Application Publication No. 2017-198917 have a negative charging property similarly to the toner, the amount of supplied inorganic fine particle differs between the image portion and the non-image portion on the image bearing member in the development step. Since the inorganic fine particles liberated from the toner particle have a smaller particle diameter than the toner, they are not completely blocked by the cleaning blade, and some of the inorganic fine particles slip through the cleaning blade. Since more inorganic fine particles slip through in the image portion, to which more inorganic fine particles are supplied, than in the non-image portion, the charge quantity in a portion that becomes an image portion and a portion that becomes a non-image portion after the exposure step becomes non-uniform even before the charging step due to the inorganic fine particles that slipped through the cleaning blade. Therefore, a difference occurs in charge quantity on the image bearing member after the charging step between the portion that becomes the image portion and the portion that becomes the non-image portion after the exposure step, and the abovementioned image defect occurs.

Further, as described above, in the development step, the amount of the supplied inorganic fine particles differs between the image portion and the non-image portion on the image bearing member, hence, the inorganic fine particle layer is difficult to form in the non-image portion where the supply amount of inorganic fine particles is particularly small. Therefore, where the addition amount of the inorganic fine particles is reduced, a toner melt-adhesion product is generated particularly remarkably in the non-image area. Meanwhile, where the addition amount is increased, an image defect due to the difference in the supply amount of the inorganic fine particles between the image portion and the non-image portion on the image bearing member becomes more remarkable.

Further, the present inventors examined the toner described in Japanese Patent Application Publication No. 2014-66784 and found the followings.

In the toner described in Japanese Patent Application Publication No. 2014-66784, the metal soap particles added to the toner particle can act as a lubricant between the cleaning blade and the image bearing member to reduce the coefficient of friction. As a result, the amount of heat generated by rubbing between the cleaning blade and the image bearing member is reduced, and the formation of the toner melt-adhesion product on the image bearing member can be suppressed.

However, in order to maintain the above lubricity, at least a certain amount of metal soap particles has to be present on the surface of the toner particle. Generally, metal soap particles are formed of a long-chain aliphatic carboxylic acid and polyvalent metal ions, as typified by zinc stearate and the like. Since the long-chain aliphatic carboxylic acid segment, which is a small molecule, has a low Young's modulus and is easily plastically deformed, the inorganic fine particles are likely to be embedded in the metal soap particles, and the amount of the metal soap particles on the surface of the toner particle is likely to be reduced. Therefore, the action of the metal soap particles as a lubricant is easily impaired by the inorganic fine particles, and image defects such as a decrease in image density in the transfer step may occur.

It follows from the above that it is difficult to suppress the generation of toner melt-adhesion products in the toner cleaning step, and to suppress a difference in density occurring when, after same image (e.g., a non-full-scale solid image) continuous formation, a halftone image different from the same image is formed, and moreover to improve image density stability in the transfer step at the same time. There is an urgent need to develop a negative-charging toner that can continuously output highly stable images even in high-speed machines while exhibiting excellent image quality.

A negative-charging toner of the present disclosure comprises:

a toner particle comprising a binder resin; and

an organic-inorganic composite fine particle comprising resin fine particles and inorganic fine particles A, wherein

the organic-inorganic composite fine particle is negative charging;

the organic-inorganic composite fine particle has a structure in which at least a part of the inorganic fine particle A is embedded in the resin fine particle;

a number average particle diameter Db of the organic-inorganic composite fine particle is 50 to 350 nm; and

a plurality of convex portions derived from the inorganic fine particles A are present on the surface of the organic-inorganic composite fine particle.

According to the present disclosure, it is possible to provide a negative-charging toner that makes it possible to suppress the generation of toner melt-adhesion products on the image bearing member in the toner cleaning step, and to suppress the occurrence of a difference in density even when, after same image (e.g., a non-full-scale solid image) continuous formation, a halftone image different from the same image is formed, and moreover to ensure high-level image density stability in the transfer step at the same time.

Further features of the present invention will become apparent from the following description of exemplary embodiments with reference to the attached drawings.

### BRIEF DESCRIPTION OF THE DRAWINGS

The FIGURE is a schematic diagram of a heat sphering treatment device.

### DESCRIPTION OF THE EMBODIMENTS

In the present disclosure, the description of “from XX to YY” or “XX to YY” indicating a numerical range means a numerical range including a lower limit and an upper limit which are end points, unless otherwise specified.

The reference numerals in the FIGURE have the following meaning. 1: raw material quantitative supply means, 2: compressed gas flow rate adjusting means, 3: introducing pipe, 4: protruding member, 5: supply pipe, 6: treatment chamber, 7: hot air supply means, 8 (8-1, 8-2, 8-3): cold air supply means, 9: regulating means, 10: recovery means, 11: hot air supply means outlet, 12: distributing member, 13: swivel member, 14: powder particle supply port

A negative-charging toner of the present disclosure comprises:

a toner particle comprising a binder resin; and

an organic-inorganic composite fine particle comprising resin fine particles and inorganic fine particles A, wherein

the organic-inorganic composite fine particle is negative charging;

the organic-inorganic composite fine particle has a structure in which at least a part of the inorganic fine particle A is embedded in the resin fine particle;

a number average particle diameter Db of the organic-inorganic composite fine particle is 50 to 350 nm; and

a plurality of convex portions derived from the inorganic fine particles A are present on the surface of the organic-inorganic composite fine particle.

As described above, with the toner containing the inorganic fine particles as described in Japanese Patent Application Publication No. 2017-198917, there was still room for improvement in terms of suppressing the generation of toner melt-adhesion products on the image bearing member in the toner cleaning step, and also suppressing image defects with a difference in density between an image portion and a non-image portion in the same image occurring when the same image is continuously formed and then a halftone image different from the same image is formed. Diligent studies conducted by the present inventors have shown that the aforementioned trade-off problem cannot be resolved by regulating the amount of inorganic fine particles in a toner and the adhesion rate thereto which is generally known as a method for controlling the amount of inorganic fine particles supplied on the image bearing member.

Therefore, the present inventors have analyzed in detail the size and porosity of the layer formed by the fine particles on the cleaning blade and the adhesive force between the fine particles when the toner containing the toner particles and the external additive fine particles is used, and have verified the effect on the generation of toner melt-adhesion products. As a result, it was found that not only the size of the layer contributing to the distance from the heat generating portion but also the porosity of the fine particle layer and the adhesive force between the fine particles are important for the influence on the generation of the toner melt-adhesion products. It was found that this is because when the toner that has not been transferred penetrates into the fine particle layer formed on the cleaning blade, the fine particle layer is less likely to be destroyed and the size of the layer is likely to be maintained if the porosity of the fine particle layer and the adhesive force between the fine particles are high.

Next, the number of the fine particles present on the image bearing member before and after passing through the cleaning blade was analyzed and compared in detail in the image portion and the non-image portion, and the effect on the difference in density between the image portion and the non-image portion that occurs when the same image is continuously formed and then a halftone image different from the same image is formed was verified. As a result, it was found that the effect on the difference in density between the image portion and the non-image portion depends on the difference in the number of fine particles present on the image bearing member after passing through the cleaning blade between the image portion and the non-image portion. That is, since a certain amount of toner is continuously supplied to the image portion, the frequency at which the fine particles contained in the toner slip through the cleaning blade increases, and as a result, there is a difference in the number of fine particles between the image portion and the non-image portion after passing through the cleaning blade.

Based on the above factor analysis, it was found that by controlling the porosity of the fine particle layer made of the fine particles and the adhesive force between the fine particles by controlling the fine particles contained in the toner, and further by controlling the charging performance of the fine particle to have the opposite polarity to that of the toner, it is possible to suppress the difference in the number of fine particles supplied on the image bearing member in the development step between the image portion and the non-image portion, thereby making it possible to overcome the abovementioned trade-off.

The toner of the present disclosure is a negative-charging toner including a toner particle including a binder resin, and organic-inorganic composite fine particles including resin fine particles and inorganic fine particles A. The organic-inorganic composite fine particles are positively charging. That is, the organic-inorganic composite fine particles have a charging performance opposite in polarity to that of the toner. As a result, the difference in the number of fine particles between the image portion and the non-image portion after passing through the cleaning blade is suppressed, and the difference in density between the image portion and the non-image portion occurring when the same image is continuously formed and then a halftone image different from the same image is formed can be prevented.

The inorganic fine particles A are not particularly limited, but from the standpoint of adhesion to the surface of the toner particle, inorganic oxide particle of at least one type selected from the group consisting of silica, titanium oxide, and alumina are preferable, and silica is more preferable.

On the surface of the organic-inorganic composite fine particles, there is a plurality of convex portions derived from the inorganic fine particles A. Further, the organic-inorganic composite fine particles have a structure in which at least a part of the inorganic fine particles A is embedded in the resin fine particles. With this configuration, when the organic-inorganic composite fine particles form a fine particle layer on the cleaning blade, the convex portions derived from a plurality of inorganic fine particles A mesh between the organic-inorganic composite fine particles, thereby making it possible to reduce the porosity. Further, because of a structure in which at least a part of the inorganic fine particles A is embedded in the resin fine particles, it is possible to partially develop a strong adhesive force between resin portions. As a result, the porosity of the fine particle layer formed on the cleaning blade is reduced and a strong adhesive force acts between the fine particles, so that the fine particle layer is not destroyed and the size of the fine particle layer can be maintained. As a result, the generation of toner melt-adhesion products can be effectively suppressed.

Furthermore, the convex portions present on the surface of the organic-inorganic composite fine particles are derived from the inorganic fine particles A. Since the convex portions are formed by the inorganic fine particles A having a high Young's modulus, the shape of the convex portions is unlikely to change even when a load is applied in the developing device during continuous use. As a result, the desired porosity and the adhesive force between the fine particles can be stably maintained.

The amount of the inorganic fine particles A is preferably from 15 parts by mass to 75 parts by mass with respect to 100 parts by mass of the resin fine particles.

Here, when a simple resin fine particle having no convex portions derived from the inorganic fine particle A is used in the toner instead of the organic-inorganic composite fine particle, a high adhesive force can be obtained between the fine particles, but since the desired porosity derived from the convex portions cannot be obtained, the generation of toner melt-adhesion products cannot be suppressed. Further, it is conceivable that where convex portions are not present, the inorganic fine particles A are completely embedded inside the resin fine particles, and this is also the reason why the generation of toner melt-adhesion products cannot be suppressed. Meanwhile, when inorganic fine particles such as non-spherical silica are used in a toner instead of the organic-inorganic composite fine particles, the desired porosity may be obtained depending on the shape, but high adhesion between the fine particles is not exhibited, so that it is not possible to suppress the generation of toner melt-adhesion products.

The number average particle diameter Db of the organic-inorganic composite fine particles is from 50 nm to 350 nm. Where the number average particle diameter Db is 50 nm or more, the number of fine particles that pass through the cleaning blade can be reduced, so that the organic-inorganic composite fine particle layer formed on the cleaning blade becomes large and the generation of toner melt-adhesion products can be suppressed. Meanwhile, where the number average particle diameter of the organic-inorganic composite fine particles is 350 nm or less, the difference with the toner particle diameter is sufficient, so that the organic-inorganic composite fine particles can reach the vicinity of the cleaning blade while pushing up the toner, thereby making it possible to prevent the toner from mixing into the organic-inorganic composite fine particle layer.

The number average particle diameter Db of the organic-inorganic composite fine particles is preferably from 60 nm to 300 nm, and more preferably from 80 nm to 200 nm.

The number average particle diameter Db of the organic-inorganic composite fine particles is measured by the following method.

The number average particle diameter Db of the organic-inorganic composite fine particles is measured using a scanning electron microscope “S-4800” (trade name; manufactured by Hitachi, Ltd.). The toner externally attached with the organic-inorganic composite fine particles is observed, the major axis of 100 primary particles of the organic-inorganic composite fine particles is randomly measured in a field magnified up to 200,000 times, and the number average particle diameter (D1) is determined. The observation magnification is adjusted, as appropriate, according to the size of the organic-inorganic composite fine particles. Since the organic-inorganic composite fine particles include a monomer unit derived from a vinyl-based monomer comprising a nitrogen atom, the organic-inorganic composite fine particles are identified by identifying the nitrogen element with an energy dispersive X-ray analyzer.

(1) Sample Preparation

A thin layer of conductive paste is applied to a sample table (aluminum sample table 15 mm×6 mm) and a toner is sprayed thereon. Further, excess toner is removed from the sample table and sufficient drying is performed by air blowing. The sample table is set in a sample holder and the sample table height is adjusted to 36 mm with a sample height gauge.

(2) S-4800 Observation Condition Setting

Liquid nitrogen is injected into the anti-contamination trap attached to a housing of S-4800 until overflow, and allowed to stand for 30 min. “PC-SEM” of S-4800 is started and flushing (cleaning of the FE chip which is an electron source) is performed. An acceleration voltage display portion of a control panel on the screen is clicked, and a [FLUSHING] button is pushed to open a flushing execution dialog. A flushing intensity of 2 is confirmed, and flushing is executed. An emission current of from 20 μA to 40 μA which is due to flushing is confirmed. The sample holder is inserted into a sample chamber of the S-4800 housing. [ORIGIN] on the control panel is pushed to move the sample holder to an observation position.

The acceleration voltage display is clicked to open an HV setting dialog, the acceleration voltage is set to [1.1 kV] and the emission current is set to [20 μA]. In the [BASIC] tab of the operation panel, the signal selection is set to [SE], [Up (U)] and [+BSE] are selected for an SE detector, and [L.A. 100] is selected in the selection box to the right of [+BSE] to set a mode for observing with a reflected electron image. Similarly, in the [BASIC] tab of the operation panel, the probe current of the electro-optical system condition block is set to [NORMAL], a focus mode is set to [UHR], and WD is set to [4.5 mm]. An [ON] button on the acceleration voltage display of the control panel is pushed to apply the acceleration voltage.

(3) Focus Adjustment

A focus knob [COARSE] on the operation panel is rotated, and the aperture alignment is adjusted when a certain level of focusing is achieved. [ALIGN] on the control panel is clicked to display the alignment dialog, and [BEAM] is selected. STIGMA/ALIGNMENT knobs (X, Y) on the operation panel are rotated to move the displayed beam to the center of concentric circles. Next, [APERTURE] is selected and the STIGMA/ALIGNMENT knobs (X, Y) are turned one by one to align so as to stop or minimize the movement of the image. The aperture dialog is closed, and focusing is performed with autofocus. After that, the magnification is set to 80,000 (80k) times, focusing is performed using the focus knob and the STIGMA/ALIGNMENT knobs in the same manner as above, and the focus is adjusted again by autofocus. This operation is repeated again to focus. Here, where the inclination angle of the observation surface is large, the measurement accuracy of the number average particle diameter Db is likely to decrease. Therefore, by selecting simultaneous focusing on the entire observation surface when adjusting the focus, a mode with minimized inclination of the surface is selected and analyzed.

(4) Image Storage

A brightness in an ABC mode is adjusted, and an image with a size of 640 pixels×480 pixels is captured and saved. The following analysis is performed using this image file. One image is captured for one toner particle and images for at least 25 toner particles are captured.

(5) Image Analysis

The particle diameter of at least 100 organic-inorganic composite fine particles on the surface of the toner is measured to obtain the number average particle diameter. Image analysis software Image-Pro Plus ver. 5.0 is used and the number average particle diameter of the organic-inorganic composite fine particles is calculated by binarizing the image obtained by the above method. When measuring the particle diameter of the organic-inorganic composite fine particles, the maximum diameter of the organic-inorganic composite fine particles is measured. Further, the maximum diameter is measured including the convex portions derived from the inorganic fine particles A.

The same operation is repeated for at least 25 toner particles, and the average value of the number average particle diameter is obtained and taken as the number average particle diameter Db of the organic-inorganic composite fine particles.

The organic-inorganic composite fine particles and the external additives other than the organic-inorganic composite fine particles are distinguished by the following method.

In the binarized image obtained in (5) above, an image in which an image contrast difference occurs between a segment derived from the inorganic fine particle A, which is an inorganic substance, and a segment derived from the resin fine particle, which is an organic substance, is distinguished as the organic-inorganic composite fine particle of the present disclosure, and an image in which the contrast difference does not occur is distinguished as an external additive other than the organic-inorganic composite fine particle.

The number average height of the convex portions derived from the inorganic fine particles A present on the surface of the organic-inorganic composite fine particles is preferably from 5 nm to 40 nm.

Where the number average height of the convex portions derived from the inorganic fine particles A present on the surface of the organic-inorganic composite fine particles is 5 nm or more, the fine particles engage with each other like gears, so that the porosity of the fine particle layer composed of the fine particles in the cleaning portion can be controlled, thereby making it possible to suppress the generation of the toner melt-adhesion products formed on the image bearing member.

Where the number average height of the convex portions derived from the inorganic fine particles A present on the surface of the organic-inorganic composite fine particles is 40 nm or less, the adhesive force between the fine particles can be controlled not to become too high when the fine particles mesh with each other like gears. As a result, the adhesive force between the toner particles when the organic-inorganic composite fine particles adhere to the surface can be reduced, so that transfer characteristics are improved.

The number average height of the convex portions derived from the inorganic fine particles A present on the surface of the organic-inorganic composite fine particles is more preferably from 5 nm to 30 nm, and further preferably from 10 nm to 30 nm.

The number average height of the convex portions derived from the inorganic fine particles A present on the surface of the organic-inorganic composite fine particles is measured by the following method.

After separating the organic-inorganic composite fine particles contained in the toner by the method described hereinbelow, images of the organic-inorganic composite fine particles are captured with a transmission electron microscope (trade name “H7500”; manufactured by Hitachi, Ltd.). The number average height of the convex portions derived from the inorganic fine particles A is measured by utilizing the fact that an image contrast difference appears between the segment derived from the inorganic fine particle A, which is an inorganic substance, and the segment derived from the resin fine particle, which is an organic substance. The height of the convex portions derived from the inorganic fine particles A present on each of the organic-inorganic composite fine particles is measured for 100 organic-inorganic composite fine particles, and the average value thereof is taken as the number average height of the convex portions. Among the convex portions derived from the inorganic fine particles A present in each organic-inorganic composite fine particle, the height is measured for those convex portions that have the clearest contour.

Organic-inorganic composite fine particles with a particle diameter of from 5 nm to 50 nm are observed at a magnification of 500,000 times, and organic-inorganic composite fine particles with a particle diameter of more than 50 nm and up to 500 nm are observed at a magnification of 50,000 times.

The organic-inorganic composite fine particles contained in the toner are separated by the following method.

(1) A total of 5 g of the toner is placed in a sample bottle and 200 ml of methanol is added.

(2) The sample is dispersed for 5 min with an ultrasonic cleaner to separate the external additives.

(3) The toner particles and the external additives are separated by suction filtration (10 μm membrane filter).

(4) Steps (2) and (3) above are repeated until a desired sample amount is obtained.

By the above operation, the external additives containing the organic-inorganic composite fine particles are isolated from the toner. The recovered aqueous solution is centrifuged, and each external additive is separated and recovered by specific gravity. Then, the solvent is removed, the mixture is sufficiently dried in a vacuum dryer, and observation is performed.

The organic-inorganic composite fine particles include resin fine particles. The resin fine particles preferably include a vinyl-based resin.

The vinyl-based resin preferably includes a monomer unit derived from a vinyl-based monomer comprising a nitrogen atom. The vinyl-based monomer comprising a nitrogen atom preferably has at least one selected from the group consisting of an amino group, an amide group, an imide group, a quaternary ammonium base, a urethane bond, a urea bond, and a nitrogen-containing heterocycle.

Here, the monomer unit refers to a reacted form of the monomer substance in the polymer. For example, one carbon-carbon bond section in the main chain in which the vinyl-based monomer in the polymer is polymerized is taken as one unit.

Any well-known vinyl-based monomer comprising a nitrogen atom can be used, provided that the monomer has at least one selected from the group consisting of an amino group, an amide group, an imide group, a quaternary ammonium base, a urethane bond, a urea bond, and a nitrogen-containing heterocycle. By including the monomer unit derived from such a monomer in the vinyl-based resin, it becomes easy to control the organic-inorganic composite fine particles to be positive charging, which is opposite in polarity to the negative-charging toner. As a result, it is possible to suppress the difference in the number of the organic-inorganic composite fine particles supplied onto the image bearing member in the toner development step between an image portion and a non-image portion. Therefore, even when the same image is continuously formed and then a halftone image different from the same image is formed, a difference in density between an image portion and a non-image portion in the same image can be further suppressed.

Even when the monomer unit derived from the monomer having the abovementioned functional group is not included, the organic-inorganic composite fine particles can be controlled to be positive charging by, for example, including a known positive-charging charge control agent in the resin fine particles.

Specific examples of the positive-charging charge control agent include compounds such as guanidine compounds, imidazole compounds, quaternary ammonium salts, and surfactants having a quaternary ammonium salt.

Examples of the vinyl-based monomer comprising a nitrogen atom include the following monomers:

amino group-containing vinyl-based monomers such as aminoethyl acrylate, aminoethyl methacrylate, dimethylaminoethyl acrylate, dimethylaminoethyl methacrylate, diethylaminoethyl acrylate, diethylaminoethyl methacrylate, N,N-dimethylaminostyrene, methyl α-acetaminoacrylate, N-arylphenylenediamine, and the like;

amide group-containing vinyl-based monomers such as acrylamide, methacrylamide, N-methylacrylamide, N-methylmethacrylamide, N-butylacrylamide, diacetoneacrylamide, N-methylolacrylamide, N,N′-methylene-bisacrylamide, N,N-dimethylacrylamide, N,N-dibenzylacrylamide, methacrylformamide, N-methyl-N-vinylacetamide, N-vinylpyrrolidone, and the like;

imide group-containing vinyl-based monomers such as N-(4-vinylphenyl)maleinimide, N-vinyl maleinimide, and the like;

vinyl-based monomers having a urea bond such as N-vinyl-N, N′-trimethylene urea and the like;

vinyl-based monomers having a nitrogen-containing heterocycle, such as 4-vinylpyridine, 2-vinylpyridine, vinylimidazole, N-vinylpyrrole, N-vinylthiopyrrolidone, 9-vinylcarbazole, 4-methyl-5-vinylthiazole, 1-vinylindole, and the like; and

vinyl-based monomers having a quaternary ammonium base, such as trimethyl vinyl ammonium bromide, triethyl vinyl ammonium chloride, trimethylene vinyl ammonium bromide, and the like.

Here, the vinyl-based monomer having a quaternary ammonium base means a structure represented by the following general formula.

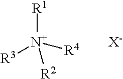

In the formula, R¹ to R⁴ independently represent arbitrary substituents such as an alkyl group, an alkenyl group, and an aryl group (however, at least one of R¹ to R⁴ includes a vinyl group), and X is any anion such as a chlorine ion, a bromine ion, and the like.

Further, as the vinyl-based monomer comprising a urethane bond and a nitrogen atom, for example, a urethane acrylate oligomer having a urethane group and an acrylic group can be used. Here, 2-[[(butylamino)carbonyl]oxy]ethyl acrylate is a specific example of the compound.

The vinyl-based resin may include a monomer unit derived from another monomer other than the vinyl-based monomer comprising a nitrogen atom. Examples of other monomers include styrene-based monomers such as styrene, α-methylstyrene, p-methyl styrene, m-methylstyrene, p-methoxystyrene, p-hydroxystyrene, p-acetoxystyrene, vinyltoluene, ethylstyrene, phenylstyrene, benzyl styrene, and the like; alkyl esters (the number of carbon atoms in the alkyl is from 1 to 18) of unsaturated carboxylic acids, such as methyl acrylate, ethyl acrylate, butyl acrylate, 2-ethylhexyl acrylate, methyl methacrylate, ethyl methacrylate, butyl methacrylate, 2-ethylhexyl methacrylate, and the like; vinyl ester-based monomers such as vinyl acetate and the like; vinyl ether-based monomers such as vinyl methyl ether; halogen element-containing vinyl-based monomers such as vinyl chloride; diene-based monomers such as butadiene, isobutylene, and the like.

These monomers may be used alone or in combination of two or more.

The vinyl-based monomer comprising a nitrogen atom may be at least one monomer selected from the group consisting of aminoethyl methacrylate, aminoethyl acrylate, methacrylamide, acrylamide, N-vinylmaleimide, 4-vinylpyridine, trimethylvinylammonium bromide, N-vinyl-N,N′-trimethyleneurea, and 2-[[(butylamino)carbonyl]oxy]ethyl acrylate.

Further, examples of the monomer unit derived from a nitrogen atom-containing vinyl-based monomer having at least one selected from the group consisting of an amino group, an amide group, an imide group, a quaternary ammonium base, a urethane bond, a urea bond and a nitrogen-containing heterocycle are presented hereinbelow.

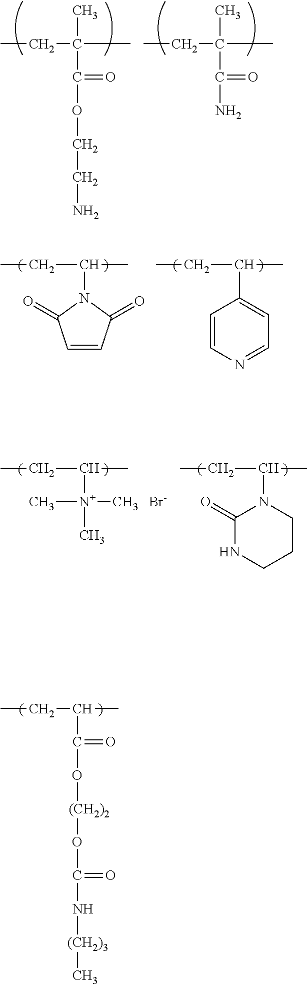

The content ratio of the monomer unit derived from the vinyl-based monomer comprising a nitrogen atom in the vinyl-based resin is preferably from 5% by mass to 30% by mass. When the content ratio of the monomer unit derived from the vinyl-based monomer comprising a nitrogen atom in the vinyl-based resin is 5% by mass or more, the organic-inorganic composite fine particles can be more easily controlled to be positive charging. Further, when the content ratio of the monomer unit derived from the nitrogen atom-containing vinyl-based monomer in the vinyl-based resin is 30% by mass or less, it is possible to suppress a decrease in the charge quantity of the negative-charging toner.

The content ratio of the monomer unit derived from the nitrogen atom-containing vinyl-based monomer in the vinyl-based resin is preferably from 7% by mass to 20% by mass.

The content ratio of the monomer unit derived from the nitrogen atom-containing vinyl-based monomer in the vinyl-based resin is measured by the following method.

A total of 20 g of a 10% by mass aqueous solution of “CONTAMINON N” (a neutral detergent for cleaning precision instruments that is composed of a nonionic surfactant, an anionic surfactant, and an organic builder and has pH 7) is measured in a 50 mL capacity vial, and 1 g of toner is mixed therewith.

The vial is set in “KM Shaker” (model: V. SX) manufactured by Iwaki Sangyo Co., Ltd., the speed is set to 50, and shaking is performed for 30 sec.

After that, in the case of magnetic toner, the organic-inorganic composite fine particles transferred to the supernatant are separated while the toner particles are restrained by using a neodymium magnet, and water is removed from the obtained dispersion liquid of the organic-inorganic composite fine particles by an evaporator to obtain a mixture of the organic-inorganic composite fine particles and CONTAMINON N.

In the case of non-magnetic toner, the toner particles and the organic-inorganic composite fine particles transferred to the supernatant are separated by a centrifuge (H-9R; manufactured by Kokusan Co., Ltd.) (at 1000 rpm for 5 min), and then, in a similar manner, water is removed from the obtained dispersion liquid of the organic-inorganic composite fine particles by an evaporator to obtain a mixture of the organic-inorganic composite fine particles and CONTAMINON N.

After the obtained mixture is sufficiently vacuum dried, the structure and composition ratio of the vinyl-based monomer are identified and calculated by measuring by nuclear magnetic resonance spectroscopy (¹H-NMR) [400 MHz, CDCl₃, room temperature (25° C.)].

Measuring device: FT NMR device JNM-EX400 (manufactured by JEOL Ltd.)

Measurement frequency: 400 MHz
Pulse condition: 5.0 μs
Frequency range: 10500 Hz
Accumulation number: 64 times

The amount of the organic-inorganic composite fine particles is preferably from 0.1 part by mass to 10 parts by mass with respect to 100 parts by mass of the toner particles.

When the amount of the organic-inorganic composite fine particles with respect to 100 parts by mass of the toner particles is 0.1 parts by mass or more, the organic-inorganic composite fine particles can efficiently form a fine particle layer on the cleaning part, thereby making it possible to suppress the generation of toner melt-adhesion products formed on the image bearing member. Where the amount of the organic-inorganic composite fine particles with respect to 100 parts by mass of the toner particles is 10 parts by mass or less, the surface of the toner particles is exposed and the fixing performance can be improved.

The amount of the organic-inorganic composite fine particles is more preferably from 0.5 parts by mass to 5 parts by mass with respect to 100 parts by mass of the toner particles.

The amount of the organic-inorganic composite fine particles with respect to 100 parts by mass of the toner particles is determined as follows assuming that 1 part by mass=1 g.

A total of 20 g of a 10% by mass aqueous solution of “CONTAMINON N” (a neutral detergent for cleaning precision instruments that is composed of a nonionic surfactant, an anionic surfactant, and an organic builder and has pH 7) is measured in a 50 mL capacity vial, and 1 g of toner is mixed therewith.

The vial is set in “KM Shaker” (model: V. SX) manufactured by Iwaki Sangyo Co., Ltd., the speed is set to 50, and shaking is performed for 30 sec. As a result, depending on the fixed state of the organic-inorganic composite fine particles, the organic-inorganic composite fine particles move from the surface of the toner particles to the dispersion liquid side.

After that, in the case of magnetic toner, the organic-inorganic composite fine particles transferred to the supernatant are separated while the toner particles are restrained by using a neodymium magnet, and the precipitated toner particles are vacuum-dried (40° C./24 h) to obtain sample A. In addition, the supernatant is transferred to an eggplant-shaped flask, and water is removed by an evaporator. After vacuum drying, the mass of sample B is measured with a precision balance.

In the case of non-magnetic toner, the toner particles and the organic-inorganic composite fine particles transferred to the supernatant are separated by a centrifuge (H-9R; manufactured by Kokusan Co., Ltd.) (at 1000 rpm for 5 min), the toner is vacuum-dried (40° C./24 h) to obtain sample A, and the mass of sample B is measured by handling the supernatant by the same method as described hereinabove.

From the masses of the obtained samples A and B and the adhesion rate described hereinbelow, the amount of the organic-inorganic composite fine particles with respect to 100 parts by mass of the toner particles is determined using the following formula.

(Amount of organic-inorganic composite fine particles with respect to 100 parts by mass of toner particles)=(Mass (g) of sample B−2 (g))/(adhesion rate)×1/(mass (g) of sample A)×100

The adhesion rate in the formula can be calculated by the method described hereinbelow.

From the viewpoint of enabling the formation of an appropriate fine particle layer in the cleaning portion and the suppression of the generation of the toner melt-adhesion product formed on the image bearing member, the adhesion rate of the organic-inorganic composite fine particles to the toner particles is preferably from 30% by number to 90% by number, and more preferably from 40% by number to 80% by number. The adhesion rate can be controlled by the processing time of the external addition step, the stirring rotation speed, the shape of a stirring blade, and the position and angle of a baffle plate.

The adhesion rate of the organic-inorganic composite fine particles to the toner particles is determined in the following manner.

A total of 20 g of a 10% by mass aqueous solution of “CONTAMINON N” (a neutral detergent for cleaning precision instruments that is composed of a nonionic surfactant, an anionic surfactant, and an organic builder and has pH 7) is measured in a 50 mL capacity vial, and 1 g of toner is mixed therewith.

The vial is set in “KM Shaker” (model: V. SX) manufactured by Iwaki Sangyo Co., Ltd., the speed is set to 50, and shaking is performed for 30 sec. As a result, depending on the fixed state of the organic-inorganic composite fine particles, the organic-inorganic composite fine particles move from the surface of the toner particles to the dispersion liquid side.

After that, in the case of magnetic toner, the organic-inorganic composite fine particles transferred to the supernatant are separated while the toner particles are restrained by using a neodymium magnet, and the precipitated toner particles are vacuum-dried (40° C./24 h) to obtain a sample A.

In the case of non-magnetic toner, the toner particles and the organic-inorganic composite fine particles transferred to the supernatant are separated by a centrifuge (H-9R; manufactured by Kokusan Co., Ltd.) (at 1000 rpm for 5 min), and the toner is vacuum-dried (40° C./24 h) to obtain a sample.

The untreated toner that has not been subjected to the above treatment and the dried sample (the toner subjected to the above treatment) are observed with a scanning electron microscope, and the organic-inorganic composite fine particles adhering to the toner particle surface are counted. The adhesion rate is determined by the following formula.

Adhesion rate (%)=(number of organic-inorganic composite fine particles of dried sample)/(number of organic-inorganic composite fine particles of untreated toner×100)

An average value measured for 100 toner particles of each of the untreated toner and the dried sample is used for the number of organic-inorganic composite fine particles to be counted. Further, the organic-inorganic composite fine particle and the external additive other than the organic-inorganic composite fine particle are distinguished by the following method.

In the binarized image obtained by the method for measuring the number average particle diameter Db of the organic-inorganic composite fine particles, an image in which an image contrast difference occurs between a segment derived from the inorganic fine particle A, which is an inorganic substance, and a segment derived from the resin fine particle, which is an organic substance, is distinguished as the organic-inorganic composite fine particle of the present disclosure, and an image in which the contrast difference does not occur is distinguished as an external additive other than the organic-inorganic composite fine particle.

The organic-inorganic composite fine particles can be produced, for example, according to the description of Examples in WO 2013/063291. When the organic-inorganic composite fine particles are produced according to the description of Examples in WO 2013/063291, the organic-inorganic composite fine particles can be produced by, for example, producing an emulsion including a metal oxide capable of forming the inorganic fine particles A and a polymerizable monomer capable of forming the resin fine particles, and then polymerizing the polymerizable monomer.

The number average particle diameter Db of the organic-inorganic composite fine particles and the number average height of the convex portions derived from the inorganic fine particles A can be adjusted by changing the particle diameter of the inorganic fine particles A used for the organic-inorganic composite fine particles and the amount ratio of the inorganic fine particles A to the resin.

The degree of hydrophobicity of the organic-inorganic composite fine particles can be controlled by hydrophobization treatment. By controlling the degree of hydrophobicity, the charging performance of the organic-inorganic composite fine particles is improved, and the fine particles can be appropriately developed and supplied to the image portion and the non-image portion. When the organic-inorganic composite fine particles are hydrophobized, a method therefor is not particularly limited and a known method can be used, but a method of treating the organic-inorganic composite fine particles with a hydrophobizing agent is preferable.

Specific examples of the hydrophobizing agent include chlorosilanes such as methyltrichlorosilane, dimethyldichlorosilane, trimethylchlorosilane, phenyltrichlorosilane, diphenyldichlorosilane, t-butyldimethylchlorosilane, vinyltrichlorosilane, and the like; alkoxysilanes such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, butyltriethoxysilane, decyltriethoxysilane, vinyl triethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, γ-(2-aminoethyl)aminopropylmethyldimethoxysilane, and the like; silazanes such as hexamethyldisilazane, hexaethyldisilazane, hexapropyldisilazan, hexabutyldisilazane, hexapentyldisilazane, hexahexyldisilazane, hexacyclohexyldisilazane, hexaphenyldisilazane, divinyltetramethyldisilazane, dimethyltetravinyldisilazane, and the like; silicone oils such as dimethylsilicone oil, methylhydrogen silicone oil, methylphenylsilicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, terminal-reactive silicone oil, and the like; siloxanes such as hexamethylcyclotrisiloxane, octamethylcyclotetrasiloxane, decamethylcyclopentasiloxane, hexamethyldisiloxane, octamethyltrisiloxane, and the like; fatty acids and metal salts thereof such as long-chain fatty acids such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, arachidonic acid and the like, and salts of these fatty acids with metals such as zinc, iron, magnesium, aluminum, calcium, sodium, lithium, and the like.

Among these, alkoxysilanes, silazanes, and straight silicone oils are preferably used because the hydrophobization treatment can be easily performed. These hydrophobizing agents may be used alone or in combination of two or more.

The toner is a negative-charging toner including a toner particle including a binder resin, and the organic-inorganic composite fine particles.

The toner particle includes a binder resin and optionally a colorant, a release agent, and the like.

Binder Resin

As the binder resin, for example, the following polymer or the like can be used.

Homopolymers of styrene and substitutes thereof such as polystyrene, poly-p-chlorostyrene, polyvinyltoluene, and the like; copolymers of styrene and substitutes thereof such as styrene-p-chlorostyrene copolymer, styrene-vinyltoluene copolymers, styrene-vinylnaphthalene copolymer, and the like; styrene-(meth)acrylic copolymers such as styrene-acrylic acid ester copolymers, styrene-methacrylic acid ester copolymers, and the like; polyester resins; hybrid resins obtained by mixing and partially reacting polyester resins and styrene-(meth)acrylic copolymer resin; polyvinyl chloride; phenol resins; natural resin-modified phenol resins; natural resin modified maleic acid resin; acrylic resins; methacrylic resins; polyvinyl acetate resins; silicone resins; polyurethane resins; polyamide resins; furan resins; epoxy resins; xylene resins; polyethylene resins; polypropylene resins, and the like.

Among them, it is preferable that at least one resin selected from the group consisting of a polyester resin, a styrene-(meth)acrylic copolymer resin, and a hybrid resin in which a polyester resin and a styrene-(meth)acrylic copolymer resin are bonded (for example, covalently bonded) be included, and it is more preferable that a polyester resin be included.

From the viewpoint of low-temperature fixability, the amount of the at least one resin selected from the group consisting of a polyester resin, a styrene-(meth)acrylic copolymer resin, and a hybrid resin in which a polyester resin and a styrene-(meth)acrylic copolymer resin are bonded (for example, covalently bonded), preferably a polyester resin, in the binder resin is preferably from 50% by mass to 100% by mass (more preferably from 80% by mass to 100% by mass).

The amount of the binder resin in the toner particle is preferably from 70% by mass to 95% by mass.

Polyhydric alcohols (divalent or trihydric or higher alcohols) and polyvalent carboxylic acids (divalent or trivalent or higher carboxylic acids), acid anhydrides thereof or lower alkyl esters thereof can be used as the monomers to be used in the polyester resin. Among them, it is preferable to use a trivalent or higher polyfunctional compound. Therefore, it is preferable to use at least one compound selected from the group consisting of a trivalent or higher carboxylic acid, an acid anhydride thereof or a lower alkyl ester thereof, and a trihydric or higher alcohol as the raw material monomers of the polyester resin.

As the polyhydric alcohol monomer to be used in the polyester resin, for example, the following polyhydric alcohol monomers can be used.

Examples of the divalent alcohol monomers include ethylene glycol, propylene glycol, 1,3-butanediol, 1,4-butanediol, 2,3-butanediol, diethylene glycol, triethylene glycol, 1,5-pentanediol, 1, 6-hexanediol, neopentyl glycol, 2-ethyl-1,3-hexanediol, hydrogenated bisphenol A, bisphenol represented by the formula (A) and derivatives thereof.

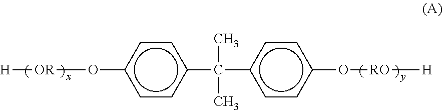

(In the formula, R is an ethylene or propylene group, x and y are integers of 0 or more, and the average value of x+y is from 0 to 10.)

Examples thereof include diols represented by the formula (B).

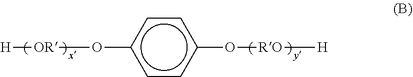

(In the formula, R′ is

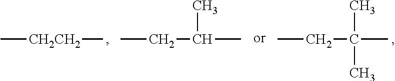

x′ and y′ are integers of 0 or more, and the average value of x′+y′ is from 0 to 10.)

Examples of trihydric or higher alcohol monomers include sorbitol, 1,2,3,6-hexanetetrol, 1,4-sorbitan, pentaerythritol, dipentaerythritol, tripentaerythritol, 1,2,4-butanetriol, 1,2,5-pentantriol, glycerol, 2-methylpropanetriol, 2-methyl-1,2,4-butanetriol, trimethylolethane, trimethylolpropane, and 1,3,5-trihydroxymethylbenzene.

Of these, glycerol, trimethylolpropane, and pentaerythritol are preferably used. These divalent alcohols and trihydric or higher alcohols can be used alone or in combination of two or more.

The following polyvalent carboxylic acid monomers can be used for the polyester resin.

Examples of divalent carboxylic acid monomers include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecyl succinic acid, isododecylsuccinic acid, n-octenylsuccinic acid, n-octylsuccinic acid, isooctenylsuccinic acid, isooctylsuccinic acid, anhydrides of these acids and lower alkyl esters thereof. Of these, maleic acid, fumaric acid, terephthalic acid, n-dodecenylsuccinic acid, and adipic acid are preferably used.

Examples of trivalent or higher carboxylic acids, acid anhydrides thereof and lower alkyl esters thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxy-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empole trimeric acid, acid anhydrides thereof and lower alkyl esters thereof.

Of these, 1,2,4-benzenetricarboxylic acid, that is, trimellitic acid, or a derivative thereof is preferably used because it is inexpensive and reaction control is easy. These divalent carboxylic acids and the like and trivalent or higher carboxylic acids can be used alone or in combination of two or more.

A method for producing the polyester resin is not particularly limited, and a known method can be used. For example, a polyester resin can be produced by loading the abovementioned alcohol monomer and carboxylic acid monomer at the same time and polymerizing through an esterification reaction, a transesterification reaction, and a condensation reaction. The polymerization temperature is not particularly limited, but is preferably in the range of from 180° C. to 290° C. When polymerizing the polyester resin, for example, a polymerization catalyst such as a titanium-based catalyst, a tin-based catalyst, zinc acetate, antimony trioxide, germanium dioxide, or the like can be used. In particular, the binder resin is more preferably a polyester resin polymerized using at least one catalyst selected from the group consisting of a tin-based catalyst and a titanium-based catalyst.

Wax may be used as the toner particles. Examples of the wax include the following.

Hydrocarbon waxes such as low molecular weight polyethylene, low molecular weight polypropylene, alkylene copolymers, microcrystalline wax, paraffin wax, and Fischer-Tropsch wax; oxides of hydrocarbon waxes such as polyethylene oxide wax or block copolymers thereof; waxes including a fatty acid ester such as carnauba wax as the main component; and completely or partially deoxidized fatty acid esters such as deoxidized carnauba wax is. Other examples are presented hereinbelow.

Saturated linear fatty acids such as palmitic acid, stearic acid, and montanic acid; unsaturated fatty acids such as brussidic acid, eleostearic acid, and parinaric acid; saturated alcohols such as stearyl alcohol, aralkyl alcohol, behenyl alcohol, carnaubyl alcohol, ceryl alcohol, and melissyl alcohol; polyhydric alcohols such as sorbitol; esters of fatty acids such as palmitic acid, stearic acid, behenic acid, and montanic acid with alcohols such and stearyl alcohol, aralkyl alcohol, behenyl alcohol, carnaubyl alcohol, ceryl alcohol, and melissyl alcohol; fatty acid amides such as linoleic acid amide, oleic acid amide, and lauric acid amide; saturated fatty acid bisamides such as methylene bisstearic acid amide, ethylene biscapric acid amide, ethylene bislauric acid amide, and hexamethylene bisstearic acid amide; unsaturated fatty acid amides such as ethylene bisoleic acid amide, hexamethylene bisoleic acid amide, N,N′-dioleyladipic acid amide, and N,N′-dioleylsebasic acid amide; aromatic bisamides such as m-xylene bisstearic acid amide and N,N′-distearyl isophthalic acid amide; aliphatic metal salts (generally called metal soaps) such as calcium stearate, calcium laurate, zinc stearate, and magnesium stearate; waxes obtained by grafting aliphatic hydrocarbon waxes with vinyl monomers such as styrene and acrylic acid; partial esterified products of fatty acids and polyhydric alcohols such as behenic acid monoglyceride; and methyl ester compounds having a hydroxyl group obtained by hydrogenation of vegetable fats and oils.

Among these waxes, from the viewpoint of improving low temperature fixability and fixing separation property, hydrocarbon waxes such as paraffin waxes and Fischer-Tropsch waxes, or fatty acid ester waxes such as carnauba wax are preferable. Hydrocarbon waxes are more preferred in that they have better hot offset resistance.

The wax is preferably used in an amount of from 3 parts by mass to 8 parts by mass per 100 parts by mass of the binder resin.

Further, in the endothermic curve at the time of temperature rise measured by a differential scanning calorimetry (DSC) device, the peak temperature of the maximum endothermic peak of the wax is preferably from 45° C. to 140° C. It is preferable that the peak temperature of the maximum endothermic peak of the wax be within the above range because both the storage stability of the toner and the hot offset resistance can be achieved at the same time.

Colorant

The toner particle may include a colorant. Examples of the colorant include the following.

Examples of black colorants include carbon black and those that have been toned to black using a yellow colorant, a magenta colorant, and a cyan colorant. As the colorant, a pigment may be used alone, or a dye and a pigment may be used in combination.

Examples of the magenta toner pigment include the following. C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, 282; C.I. Pigment Violet 19; C.I. Vat Red 1, 2, 10, 13, 15, 23, 29, 35.

Examples of magenta toner dyes include the following. C.I. Solvent Red 1, 3, 8, 23, 24, 25, 27, 30, 49, 81, 82, 83, 84, 100, 109, 121; C.I. Disperse Red 9; C.I. Solvent Violet 8, 13, 14, 21, 27; oil-soluble dyes such C.I. Disperse Violet 1, C.I. Basic Red 1, 2, 9, 12, 13, 14, 15, 17, 18, 22, 23, 24, 27, 29, 32, 34, 35, 36, 37, 38, 39, 40; C.I. Basic dyes such as Basic Violet 1, 3, 7, 10, 14, 15, 21, 25, 26, 27, 28.

Examples of the cyan toner pigment include the following. C.I. Pigment Blue 2, 3, 15:2, 15:3, 15:4, 16, 17; C.I. Vat Blue 6; C.I. Acid Blue 45, a copper phthalocyanine pigment in which 1 to 5 phthalocyanine methyl groups are substituted in the phthalocyanine skeleton.

C.I. Solvent Blue 70 is an example of dye for cyan toner.

Examples of pigments for yellow toner include the following. C.I.

Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C.I. Vat Yellow 1, 3, 20.

C.I. Solvent Yellow 162 is an example of dye for yellow toner.

These colorants can be used alone or in a mixture of two or more, and can be used in the form of a solid solution. The colorant is selected from the standpoint of hue angle, saturation, lightness, light resistance, OHP transparency, and dispersibility in toner particles.

The amount of the colorant is preferably from 0.1 part by mass to 30.0 parts by mass with respect to 100 parts by mass of the binder resin.

Charge Control Agent

The toner particle can also include a charge control agent if necessary. As the charge control agent, known ones can be used, and for example, a 3,5-di-t-butylsalicylate aluminum compound (trade name: Bontron E88, manufactured by Orient Chemical Industries Co., Ltd.) can be used.

The amount of the charge control agent is preferably from 0.01 part by mass to 3.0 part by mass with respect to 100 parts by mass of the binder resin.

Method for Producing Toner Particles

A method for producing the toner particles is not particularly limited, and a known suspension polymerization method, dissolution suspension method, emulsification/aggregation method, or pulverization method can be adopted.

Hereinafter, an example of the toner production procedure by the pulverization method will be described.

In a raw material mixing step, for example, a binder resin and, if necessary, other components such as wax, a colorant, and a charge control agent are weighed and blended and mixed in predetermined amounts as materials constituting a toner particle. Examples of the mixing device include a double cone mixer, a V-type mixer, a drum-type mixer, a super mixer, a Henschel mixer, a Nauta mixer, Mechanohybrid (manufactured by Nippon Coke Industries, Ltd.), and the like.

Next, the mixed materials are melt-kneaded to disperse the materials in the binder resin. In the melt-kneading process, batch-type kneaders such as pressure kneaders and Banbury mixers and continuous-type kneaders can be used, and single-screw or twin-screw extruders are the mainstream because of the advantage of continuous production.

Examples of the single-screw and twin-screw extruders include a KTK type twin-screw extruder (manufactured by Kobe Steel, Ltd.), a TEM-type twin-screw extruder (manufactured by Toshiba Machine Co., Ltd.), a PCM kneader (manufactured by Ikekai Iron Works Co., Ltd.), a twin-screw extruder (manufactured by KCK Co.), a co-kneader (manufactured by Buss AG), KNEADEX (manufactured by Nippon Coke & Engineering Co., Ltd.), and the like. Further, the resin composition obtained by melt-kneading may be rolled with two rolls or the like and cooled with water or the like in a cooling step.

Then, the cooled product of the resin composition is pulverized to a desired particle diameter in a pulverization step. In the pulverization step, coarse pulverization is performed with a pulverizer such as a crusher, a hammer mill, a feather mill, or the like. After that, for example, fine pulverization is performed by a cryptron system (manufactured by Kawasaki Heavy Industries, Ltd.), a super rotor (manufactured by Nisshin Engineering Co., Ltd.), a turbo mill (manufactured by Turbo Industries, Ltd.), or an air jet pulverizer.

After that, if necessary, classification is performed with a classifier or sieve such as Elbow Jet of an inertial classification type (manufactured by Nittetsu Mining Co., Ltd.), Turboplex of a centrifugal force classification type (manufactured by Hosokawa Micron Corporation), a TSP separator (manufactured by Hosokawa Micron Corporation), Faculty (manufactured by Hosokawa Micron Corporation), and the like.

After that, surface treatment of the toner particles may be performed by heating if necessary. For example, a surface treatment apparatus shown in the FIGURE can be used to perform surface treatment with hot air. An example of a method of surface-treating toner particles with hot air using the surface treatment apparatus shown in the FIGURE will be described below.

A mixture quantitatively supplied by a raw material quantitative supply means 1 is guided to an introduction pipe 3 installed on the vertical line of the raw material supply means by compressed gas adjusted by a compressed gas flow rate adjusting means 2. The mixture that has passed through the introduction pipe is uniformly dispersed by a conical protruding member 4 provided in the central portion of the raw material supply means, and is guided to supply pipes 5 in eight directions that spread radially to perform heat treatment and guided to a treatment chamber 6 where the heat treatment is to be performed.

At this time, the flow of the mixture supplied to the processing chamber is regulated by a regulating means 9 for regulating the flow of the mixture that is provided in the processing chamber. Therefore, the mixture supplied to the treatment chamber is heat-treated while swirling in the treatment chamber, and then cooled.

The hot air for heat-treating the supplied mixture is supplied from the hot air supply means 7, uniformly distributed by a distribution member 12, and introduced into the processing chamber by spirally swirling the hot air with a swirling member 13 for swirling the hot air toward a hot air supply means outlet 11. As a configuration thereof, the swirling member 13 for swirling the hot air has a plurality of blades, and the swirling of the hot air can be controlled by the number and angles of the blades. The temperature of the hot air supplied to the processing chamber at the outlet of the hot air supply means 7 is preferably from 100° C. to 300° C. Where the temperature at the outlet of the hot air supply means is within the above range, it is possible to prevent the fusion and coalescence of the toner particles due to overheating of the mixture.

The heat-treated toner particles that have been subjected to heat treatment are further cooled by cold air supplied from a cold air supply means 8 (8-1, 8-2, 8-3). The temperature of the cold air supplied from the cold air supply means 8 is preferably from −20° C. to 30° C. When the temperature of the cold air is within the above range, the heat-treated toner particles can be efficiently cooled, and the heat-treated toner particles can be prevented from being melt-adhered to each other or coalesced without impeding the uniform spheroidizing treatment of the mixture. The absolute moisture content of the cold air is preferably from 0.5 g/m³ to 15.0 g/m³.

Next, the cooled heat-treated toner particles are recovered by the recovery means 10 at the lower end of the processing chamber. A blower (not shown) is provided at the tip of the collecting means and configured to suck and convey the particles.

Further, a powder particle supply port 14 is provided so that the swirling direction of the supplied mixture is the same as the swirling direction of the hot air, and the recovery means 10 of the surface treatment device is provided on the outer peripheral portion of the treatment chamber so as to maintain the swirling direction of the swirling powder particles. Further, the configuration is such that the cold air supplied from the cold air supply means 8 is supplied horizontally and tangentially from the outer peripheral portion of the device to the peripheral surface of the processing chamber.

The swirling direction of the toner particles supplied from the powder supply port, the swirling direction of the cold air supplied from the cold air supply means, and the swirling direction of the hot air supplied from the hot air supply means are all the same. Therefore, turbulence does not occur in the treatment chamber, the swirling flow in the device is strengthened, a strong centrifugal force is applied to the toner particles, and the dispersibility of the toner particles is further improved. Therefore, toner particles including only few coalesced particles and having uniform shape can be obtained.

After that, classification may be performed as needed. For example, Elbow Jet of an inertial classification type (manufactured by Nittetsu Mining Co., Ltd.) can be used.

The surface of the heat-treated toner particles is subjected to external addition treatment with a desired amount (preferably from 0.1 parts by mass to 10 parts by mass, more preferably from 0.5 parts by mass to 5 parts by mass with respect to 100 parts by mass of the toner particles) of organic-inorganic composite fine particles.

An external addition treatment method can be exemplified by a method of kneading and mixing by using a mixing device such as a double cone mixer, a V-type mixer, a drum-type mixer, a super mixer, a Henschel mixer, a Nauta mixer, a mechano hybrid (manufactured by Nippon Coke Industries, Ltd.), Nobilta (manufactured by Hosokawa Micron Corporation), and the like as an external addition device. At that time, if necessary, an external additive other than the organic-inorganic composite fine particles, such as a fluidizing agent, may be externally treated.

A two-component developer includes a toner of the present disclosure and a magnetic carrier.

Generally, well-known materials such as iron oxide; particles of metals such as iron, lithium, calcium, magnesium, nickel, copper, zinc, cobalt, manganese, chromium, and rare earth, alloys thereof, and oxides thereof; magnetic bodies such as ferrites and the like; magnetic body-dispersed resin carriers (so-called resin carriers) including magnetic bodies and a binder resin that holds the magnetic bodies in a dispersed state; and the like can be used as the magnetic carriers.

Method for Measuring Peak Molecular Weight Mp

The peak molecular weight (Mp) of the binder resin is measured by gel permeation chromatography (GPC) in the following manner.

Special grade 2,6-di-t-butyl-4-methylphenol (BHT) is added to o-dichlorobenzene for gel chromatography so that the concentration is 0.10 mass/volume %, and dissolved at room temperature. The binder resin and the o-dichlorobenzene to which BHT has been added are placed in a sample bottle and heated on a hot plate set at 150° C. to dissolve the binder resin. Once the binder resin has dissolved, the solution is put in a preheated filter unit which is installed in the main body. A solution that has passed through the filter unit is used as a GPC sample. The sample solution is adjusted so that the concentration is about 0.15% by mass. This sample solution is used for measurement under the following conditions.

Apparatus: HLC-8121GPC/HT (manufactured by Tosoh Corporation)

Detector: RI for high temperature
Column: TSKgel GMHHR-H HT 2 columns (manufactured by Tosoh Corporation)

### Temperature: 135.0° C.

Solvent: o-dichlorobenzene for gel chromatography
(BHT 0.10 mass/volume % added)
Flow velocity: 1.0 ml/min
Injection volume: 0.4 ml

In calculating the molecular weight of the binder resin, standard polystyrene resins (for example, trade name “TSK standard polystyrenes F-850, F-450, F-288, F-128, F-80, F-40, F-20, F-10, F-4, F-2, F-1, A-5000, A-2500, A-1000, A-500”, manufactured by Tosoh Corporation) are used to create molecular weight calibration curve which is used to calculate a peak value.

Method for Measuring Softening Point Tm and Glass Transition Temperature Tg

The softening point Tm of the binder resin is measured using a constant load extrusion type thin tube rheometer “Device for Evaluating Flow Characteristics, Flow Tester CFT-500D” (manufactured by Shimadzu Corporation). With the CFT-500D, a measurement sample filled in a cylinder is melted, while applying a constant load from above with a piston and raising the temperature, and pushed out from the thin tube hole at the bottom of the cylinder, and a graph of a flow curve can be plotted from the piston descent amount (mm) at this time and the temperature (° C.).

The “melting temperature in the ½ method” described in the manual provided with the “Device for Evaluating Flow Characteristics, Flow Tester CFT-500D” is taken as the softening point (Tm).

The melting temperature in the ½ method is calculated as follows.

First, ½ of the difference between the piston descent amount at the end of the outflow (outflow end point, Smax) and the piston descent amount at the start of the outflow (minimum point, Smin) is determined (assuming this is X, X=(Smax−Smin)/2). Then, the temperature at the flow curve when the piston descent amount is the sum of X and Smin is defined as the melting temperature in the ½ method.

A columnar product having a diameter of about 8 mm and prepared by compression molding about 1.2 g of the binder resin at about 10 MPa for about 60 sec in an environment of 25° C. by using a tablet molding compressor (for example, standard manual Newton Press NT-100H, manufactured by NPA System Co., Ltd.) is used as a measurement sample. Specific operations in the measurement are performed according to the manual provided with the device.

The measurement conditions for CFT-500D are as follows.

Test mode: temperature rise method
Starting temperature: 60° C.
Reached temperature: 200° C.
Measurement interval: 1.0° C.
Temperature rise rate: 4.0° C./min
Piston cross-sectional area: 1.000 cm²
Test load (piston load): 5.0 kgf
Preheating time: 300 sec
Die hole diameter: 1.0 mm
Die length: 1.0 mm

The glass transition temperature Tg of the binder resin is measured using a differential scanning calorimeter (DSC/METTLER TOLEDO: DSC822/EK90). Specifically, from 0.01 g to 0.02 g of the sample is weighed in an aluminum pan, followed by raising the temperature to 200° C. and cooling from that temperature to 0° C. at a temperature lowering rate of 10° C./min, and the calorific value of the sample is measured while raising the temperature again at a temperature rise rate of 10° C./min. Next, from the obtained DSC curve, the temperature at the intersection of a straight line extending the baseline on a low temperature side to a high temperature side and a tangent line drawn at a point where the gradient of the curve of a stepwise change portion of glass transition is maximized is taken as the glass transition temperature.

### EXAMPLES

Hereinafter, the present disclosure will be described in more detail with reference to Examples and Comparative Examples, but the embodiments of the present disclosure are not limited thereto. Unless otherwise specified, the number of parts in Examples and Comparative Examples is based on mass.

Binder Resin; Production Example of Polyester Resin

Polyoxypropylene (2.2)-2,2-Bis (4-Hydroxyphenyl) Propane:

73.8 parts (0.19 mol; 100.0 mol % based on the total number of moles of polyhydric alcohol)

Terephthalic Acid:

12.5 parts (0.08 mol; 48.0 mol % with respect to the total number of moles of polyvalent carboxylic acid)

Adipic Acid:

7.8 parts (0.05 mol; 34.0 mol % with respect to the total number of moles of polyvalent carboxylic acid)

Titanium Tetrabutoxide (Esterification Catalyst): 0.5 Parts

The above materials were weighed in a reaction vessel equipped with a cooling pipe, a stirrer, a nitrogen introduction pipe, and a thermocouple. Next, the inside of the flask was replaced with nitrogen gas, the temperature was gradually raised while stirring, and the reaction was carried out for 2 h while stirring at a temperature of 200° C.

Further, the pressure in the reaction vessel was lowered to 8.3 kPa and maintained for 1 h, followed by cooling to 160° C. and returning to atmospheric pressure (first reaction step).

Trimellitic Acid:

5.9 parts (0.03 mol; 18.0 mol % with respect to the total number of moles of polyvalent carboxylic acid)

Tert-Butylcatechol (Polymerization Inhibitor): 0.1 Part

After that, the above materials were added, the pressure in the reaction vessel was lowered to 8.3 kPa, and the reaction was carried out for 15 h while maintaining the temperature at 200° C. After confirming that the softening point measured according to ASTM D36-86 reached the temperature of 120° C., the temperature was lowered to stop the reaction (second reaction step), and a binder resin was obtained. The obtained binder resin had a peak molecular weight Mp of 10000, a softening point Tm of 110° C., and a glass transition temperature Tg of 60° C.

### Production Examples of Organic-Inorganic Composite Fine Particles 1 to 13

Organic-inorganic composite fine particles 1 to 13 were produced according to Example 1 of WO 2013/063291, except that 16.5 g of methacryloxypropyltrimethoxysilane (MPS) was replaced with the monomer shown in Table 1, and the addition amount of colloidal silica was changed so that the amount of colloidal silica in the organic-inorganic composite fine particles became such as shown in Table 1. All of the organic-inorganic composite fine particles 1 to 13 were positive charging and had a structure in which at least a part of the inorganic fine particles A was embedded in the resin fine particles. A plurality of convex portions derived from the inorganic fine particles A was present on the surface of the organic-inorganic composite fine particles. Table 1 shows the physical characteristics of the organic-inorganic composite fine particles 1 to 13.

TABLE 1

| | Resin fine particles (vinyl-based resin) | | | | Inorganic fine particles A | | | |
|---|---|---|---|---|---|---|---|---|
| Organic-inorganic | Vinyl-based monomer comprising a nitrogen atom | | Other monomers | | Colloidal silica | | | |
| composite | | Content ratio | | Content ratio | Particle diameter | *1 | Db | *2 |
| fine particles | Structure | (% by mass) | Structure | (% by mass) | (nm) | (parts) | (nm) | (nm) |
| 1 | Aminoethyl methacrylate | 10 | MPS | 90 | 20 | 45 | 100 | 15 |
| 2 | Aminoethyl methacrylate | 5 | MPS | 95 | 20 | 45 | 100 | 15 |
| 3 | Aminoethyl methacrylate | 25 | MPS | 75 | 20 | 45 | 100 | 15 |
| 4 | Aminoethyl methacrylate | 10 | MPS | 90 | 20 | 70 | 60 | 15 |
| 5 | Aminoethyl methacrylate | 10 | MPS | 90 | 20 | 15 | 300 | 15 |
| 6 | Aminoethyl methacrylate | 10 | MPS | 90 | 10 | 45 | 100 | 5 |
| 7 | Aminoethyl methacrylate | 10 | MPS | 90 | 60 | 15 | 300 | 40 |
| 8 | Methacrylamide | 10 | MPS | 90 | 20 | 45 | 100 | 15 |
| 9 | N-vinylmaleimide | 10 | MPS | 90 | 20 | 45 | 100 | 15 |
| 10 | 4-Vinyl pyridine | 10 | MPS | 90 | 20 | 45 | 100 | 15 |
| 11 | Trimethylvinyl ammonium bromide | 10 | MPS | 90 | 20 | 45 | 100 | 15 |
| 12 | N-vinyl-N,N′-trimethyleneurea | 10 | MPS | 90 | 20 | 45 | 100 | 15 |
| 13 | 2-[[(Butylamino)carbonyl]oxy]ethyl acrylate | 10 | MPS | 90 | 20 | 45 | 100 | 15 |
| 14 | — | — | MPS | 100 | 20 | 45 | 100 | 15 |
| 15 | Aminoethyl methacrylate | 10 | MPS | 90 | 20 | 85 | 35 | 15 |
| 16 | Aminoethyl methacrylate | 10 | MPS | 90 | 20 | 10 | 400 | 15 |

*1: Amount with respect to 100 parts of resin fine particles (parts)
*2: Number average height of convex portions (nm)

### Production Example of Inorganic Fine Particles 1

A base material of silica fine particles having a number average particle diameter of 100 nm and a BET specific surface area of 35 m²/g was surface-treated with 50 cSt silicone oil to obtain inorganic fine particles 1. The inorganic fine particles 1 were negative charging, did not have a structure in which at least a part of the inorganic fine particles A was embedded in the resin fine particles, and had no convex portions derived from the inorganic fine particles A on the surface.

### Production Example of Inorganic Fine Particles 2

A base material of silica fine particles having a number average particle diameter of 100 nm and a BET specific surface area of 35 m²/g was surface-treated with 50 cSt amino-modified silicone oil to obtain inorganic fine particles 2. The inorganic fine particles 2 were positive charging, did not have a structure in which at least a part of the inorganic fine particles A was embedded in the resin fine particles, and had no convex portions derived from the inorganic fine particles A on the surface.

### Production Example of Resin Fine Particles 1

| | |
|---|---|
| Styrene | 85 parts |
| n-Butyl acrylate | 10 parts |
| Divinylbenzene | 5 parts |

The above materials were mixed to prepare a monomer solution. An aqueous solution prepared by dissolving 3 parts of an anionic surfactant (manufactured by Daiichi Kogyo Seiyaku Co., Ltd.: NEOGEN RK) in 400 parts of ion-exchanged water and the monomer solution were put into a two-necked flask, and stirring and emulsification were performed at a rotation speed of 10,000 r/min by using a homogenizer (manufactured by IKA: Ultra Turrax T50). Then, the inside of the flask was replaced with nitrogen, and the contents were heated to 70° C. in a water bath while stirring slowly, and then 7 parts of ion-exchanged water in which 3 parts of ammonium persulfate was dissolved was added to initiate polymerization. After continuing the reaction for 8 h, the reaction solution was cooled to room temperature. A total of 50 parts of a 10% by mass NaCl aqueous solution was mixed with the obtained aqueous dispersion of the fine particles, and the resin fine particles were salted out, washed with water a plurality of times, filtered and dried to obtain the resin fine particles 1.

The resin fine particles 1 were negative charging, did not have a structure in which at least a part of the inorganic fine particles A was embedded in the resin fine particles, and had no convex protrusions derived from the inorganic fine particles A on the surface.

### Production Example of Resin Fine Particles 2

| | |
|---|---|
| Styrene | 85 parts |
| Aminoethyl methacrylate | 10 parts |
| Divinylbenzene | 5 parts |

The above materials were mixed to prepare a monomer solution. An aqueous solution prepared by dissolving 3 parts of an anionic surfactant (manufactured by Daiichi Kogyo Seiyaku Co., Ltd.: NEOGEN RK) in 400 parts of ion-exchanged water and the monomer solution were put into a two-necked flask, and stirring and emulsification were performed at a rotation speed of 10,000 r/min by using a homogenizer (manufactured by IKA: Ultra Turrax T50). Then, the inside of the flask was replaced with nitrogen, and the contents were heated to 70° C. in a water bath while stirring slowly, and then 7 parts of ion-exchanged water in which 3 parts of ammonium persulfate was dissolved was added to initiate polymerization. After continuing the reaction for 8 h, the reaction solution was cooled to room temperature. A total of 50 parts of a 10% by mass NaCl aqueous solution was mixed with the obtained aqueous dispersion of the fine particles, and the resin fine particles were salted out, washed with water a plurality of times, filtered and dried to obtain the resin fine particles 2.

The resin fine particles 2 were positive charging, did not have a structure in which at least a part of the inorganic fine particles A was embedded in the resin fine particles, and had no convex protrusions derived from the inorganic fine particles A on the surface.

### Production Example of Toner 1

| | | |
|---|---|---|
| Binder resin | 100 | parts |
| Fischer-Tropsch wax (peak temperature of maximum | 4 | parts |
| endothermic peak is 90° C.) | | |
| 3,5-di-t-Butylsalicylic acid aluminum compound | 0.3 | parts |
| (Bontron E88, manufactured by Orient Chemical | | |
| Industry Co., Ltd.) | | |
| Carbon black | 10 | parts |

The above materials were mixed using a Henschel mixer (FM-75 type, manufactured by Mitsui Kosan KK) at a rotation speed of 1500 rpm and a rotation time of 5 min, and then kneaded with a twin-screw kneader (PCM-30 type, set to a temperature of 130° C., manufactured at Ikegai Corp.). The obtained kneaded product was cooled and coarsely pulverized to 1 mm or less with a hammer mill to obtain a coarsely pulverized product. The obtained pulverized product was finely pulverized with a mechanical pulverizer (T-250, manufactured by Turbo Industries, Ltd.). Further, using Faculty (F-300, manufactured by Hosokawa Micron Corporation), classification was performed to obtain toner particles. The operating conditions were a classification rotor rotation speed of 11,000 rpm and a distributed rotor rotation speed of 7200 rpm.

After the above step, heat treatment was performed by the surface treatment apparatus shown in the FIGURE to obtain heat-treated toner particles. The operating conditions were as follows: feed amount=5 kg/hr, hot air temperature=160° C., hot air flow rate=6 m³/min, cold air temperature=−5° C., cold air flow rate=4 m³/min, blower air volume=20 m³/min, and injection air flow rate=1 m³/min.

The obtained heat-treated toner particles were adjusted so as to obtain a desired particle diameter distribution and center particle diameter by using Elbow Jet of an inertial classification type (manufactured by Nittetsu Mining Co., Ltd.) under the following operating conditions: feed amount=5 kg/hr, an F classification edge (fine powder classification edge) of from 3 mm to 5 mm, and a G classification edge (coarse powder classification edge) maximized and closed.

Heat-treated toner particles: 100 parts

Organic-inorganic composite fine particles 1:1.0 part

The above materials were mixed with a Henschel mixer (FM-75 type, manufactured by Mitsui Miike Machinery Co., Ltd.) at a rotation speed of 1900 rpm and a rotation time of 3 min to obtain toner 1.

### Production Examples of Toners 2 to 21

Toners 2 to 21 were obtained by performing the same operations as in the production example of toner 1, except that the type of the organic-inorganic composite fine particles, inorganic fine particles or resin fine particles, the number of parts added, and the adhesion rate (the external addition conditions were adjusted as shown in Table 2) were changed as shown in Table 2. The physical characteristics are shown in Table 2.

TABLE 2

| | External additive | | | | | |
|---|---|---|---|---|---|---|
| | | parts | Db | Adhesion rate | Rotation speed | Rotation time |
| Toner | Type | added | (nm) | (% by number) | (rpm) | (min) |
| 1 | Organic-inorganic composite fine particles 1 | 1.0 | 100 | 50 | 1,900 | 3 |
| 2 | Organic-inorganic composite fine particles 1 | 0.3 | 100 | 50 | 1,900 | 3 |
| 3 | Organic-inorganic composite fine particles 1 | 3.0 | 100 | 50 | 1,900 | 3 |
| 4 | Organic-inorganic composite fine particles 1 | 1.0 | 100 | 30 | 1,900 | 1 |
| 5 | Organic-inorganic composite fine particles 1 | 1.0 | 100 | 80 | 1,900 | 10 |
| 6 | Organic-inorganic composite fine particles 2 | 1.0 | 100 | 50 | 1,900 | 3 |
| 7 | Organic-inorganic composite fine particles 3 | 1.0 | 100 | 50 | 1,900 | 3 |
| 8 | Organic-inorganic composite fine particles 4 | 1.0 | 60 | 50 | 1,900 | 3 |
| 9 | Organic-inorganic composite fine particles 5 | 1.0 | 300 | 50 | 1,900 | 6 |
| 10 | Organic-inorganic composite fine particles 6 | 1.0 | 100 | 50 | 1,900 | 3 |
| 11 | Organic-inorganic composite fine particles 7 | 1.0 | 300 | 50 | 1,900 | 6 |
| 12 | Organic-inorganic composite fine particles 8 | 1.0 | 100 | 50 | 1,900 | 3 |
| 13 | Organic-inorganic composite fine particles 9 | 1.0 | 100 | 50 | 1,900 | 3 |
| 14 | Organic-inorganic composite fine particles 10 | 1.0 | 100 | 50 | 1,900 | 3 |
| 15 | Organic-inorganic composite fine particles 11 | 1.0 | 100 | 50 | 1,900 | 3 |
| 16 | Organic-inorganic composite fine particles 12 | 1.0 | 100 | 50 | 1,900 | 3 |
| 17 | Organic-inorganic composite fine particles 13 | 1.0 | 100 | 50 | 1,900 | 3 |
| 18 | Organic-inorganic composite fine particles 14 | 1.0 | 100 | 50 | 1,900 | 3 |
| 19 | Organic-inorganic composite fine particles 15 | 1.0 | 35 | 50 | 1,900 | 2 |
| 20 | Organic-inorganic composite fine particles 16 | 1.0 | 400 | 50 | 1,900 | 6 |
| 21 | Inorganic fine particles 1 | 1.0 | 100 | 50 | 1,900 | 3 |
| 22 | Inorganic fine particles 2 | 1.0 | 100 | 50 | 1,900 | 3 |
| 23 | Resin fine particles 1 | 1.0 | 100 | 50 | 1,900 | 3 |
| 24 | Resin fine particles 2 | 1.0 | 100 | 50 | 1,900 | 3 |

### Production Example of Magnetic Core Particles

Step 1 (Weighing/Mixing Step):

| | | |
|---|---|---|
| Fe₂O₃ | 62.7 | parts |
| MnCO₃ | 29.5 | parts |
| Mg(OH)₂ | 6.8 | parts |
| SrCO₃ | 1.0 | part |

The ferrite raw materials were weighed so that the above materials had the above composition ratio. Then, the materials were pulverized and mixed for 5 h with a dry vibration mill using stainless beads having a diameter of ⅛ inch.

Step 2 (Pre-Firing Step):

The obtained pulverized product was made into pellets of about 1 mm square with a roller compactor. Coarse powder was removed from the pellets with a vibrating sieve having an opening of 3 mm, and then fine powder was removed with a vibrating sieve having an opening of 0.5 mm, followed by firing at a temperature of 1000° C. for 4 h in a nitrogen atmosphere (oxygen concentration 0.01% by volume) to prepare a pre-fired ferrite. The composition of the obtained pre-fired ferrite was as follows.

(MnO)ₐ(MgO)_{b}(SrO)_{c}(Fe₂O₃)_{d}

In the above formula, a=0.257, b=0.117, c=0.007, d=0.393.

Step 3 (Pulverization Step):

The obtained pre-fired ferrite was pulverized to about 0.3 mm with a crusher, then 30 parts of water was added to 100 parts of the per-fired ferrite using zirconia beads having a diameter of ⅛ inch, and pulverization was performed with a wet ball mill for 1 h. The obtained slurry was pulverized with a wet ball mill using alumina beads having a diameter of 1/16 inch for 4 h to obtain a ferrite slurry (a finely pulverized product of the pre-fired ferrite).

Step 4 (Granulation Step):

A total of 1.0 part of ammonium polycarboxylic acid as a dispersant and 2.0 parts of polyvinyl alcohol as a binder were added to the ferrite slurry with respect to 100 parts of the pre-fired ferrite, and granulation into spherical particles was performed with a spray dryer (manufacturer: Ohkawara Kakohki Co., Ltd.). After adjusting the particle diameter of the obtained particles, the particles were heated at 650° C. for 2 h using a rotary kiln to remove organic components of the dispersant and binder.

Step 5 (Firing Step):

In order to control the firing atmosphere, the temperature was raised from room temperature to a temperature of 1300° C. in 2 h under a nitrogen atmosphere (oxygen concentration 1.00% by volume) in an electric furnace, and then firing was performed at a temperature of 1150° C. for 4 h. Then, over 4 h, the temperature was lowered to 60° C., the atmosphere was restored from the nitrogen atmosphere to normal, and the mixture was taken out at a temperature of 40° C. or lower.

Step 6 (Sorting Step):

After pulverizing the agglomerated particles, the low-magnetic-force product was cut by magnetic beneficiation and sieved with a sieve having a mesh size of 250 μm to remove coarse particles and obtain magnetic core particles having a 50% particle diameter (D50) of 37.0 μm based on volume distribution.

Preparation of Coating Resin

| | |
|---|---|
| Cyclohexyl methacrylate monomer | 26.8% by mass |
| Methyl methacrylate monomer | 0.2% by mass |
| Methyl methacrylate macromonomer | 8.4% by mass |
| (macromonomer having a methacryloyl | |
| group at one end and having a weight | |
| average molecular weight of 5000) | |
| Toluene | 31.3% by mass |
| Methyl ethyl ketone | 31.3% by mass |
| Azobisisobutyronitrile | 2.0% by mass |

Of the above materials, the cyclohexyl methacrylate monomer, methyl methacrylate monomer, methyl methacrylate macromonomer, toluene, and methyl ethyl ketone were placed in a four-port separable flask equipped with a reflux condenser, a thermometer, a nitrogen introduction tube, and a stirrer, and nitrogen gas was introduced to create a sufficiently nitrogen atmosphere. Then, heating to 80° C. was performed, azobisisobutyronitrile was added, and the mixture was refluxed for 5 h for polymerization. Hexane was injected into the obtained reaction product to precipitate a copolymer, and the precipitate was filtered off and then vacuum dried to obtain a coating resin.

Next, 30 parts of the coating resin was dissolved in 40 parts of toluene and 30 parts of methyl ethyl ketone to obtain a polymer solution (solid fraction: 30% by mass).

Preparation of Coating Resin Solution 1

The followings were dispersed in a paint shaker for 1 h using zirconia beads having a diameter of 0.5 mm:
Polymer solution (resin solid fraction concentration 30%): 33.3% by mass; Toluene: 66.4% by mass; and
Carbon black Regal 330 (manufactured by Cabot Corporation): 0.3% by mass (primary particle diameter 25 nm, nitrogen adsorption specific surface area 94 m²/g, DBP oil absorption 75 mL/100 g).
The obtained dispersion liquid was filtered through a 5.0 μm membrane filter to obtain a coating resin solution.

### Production Example of Magnetic Carrier

### Resin Coating Step:

The magnetic core particles and the coating resin solution were loaded into a vacuum degassing type kneader maintained at room temperature (the amount of the coating resin solution loaded was 2.5 parts as a resin component with respect to 100 parts of the magnetic core particles). After the loading, stirring was performed at a rotation speed of 30 rpm for 15 min, the solvent was volatilized above a certain level (80% by mass), the temperature was raised to 80° C. while mixing under reduced pressure, and toluene was distilled off over 2 h, followed by cooling. A low-magnetic-force product was separated from the obtained magnetic carrier by magnetic beneficiation, and after passing through a sieve having an opening of 70 μm, classification with a wind power classifier was performed to obtain a magnetic carrier having a 50% particle diameter (D50) of 38.2 μm based on volume distribution.

### Production Example of Two-Component Developer 1

A total of 92.0 parts of the magnetic carrier and 8.0 parts of toner 1 were mixed with a V-type mixer (V-20, manufactured by Seishin Enterprise Co., Ltd.) to obtain a two-component developer 1.

### Production Example of Two-Component Developers 2 to 21

Two-component developers 2 to 21 were obtained by performing the same operations as in the production example of the two-component developer 1, except that the type of the toner was changed as shown in Table 3.

### Example 1

The two-component developer 1 was put into a developing device of the following image forming apparatus, the above toner 1 was put into a replenishment bottle, and the evaluation described hereinbelow was performed.

Cleaning Evaluation: Evaluation of Number of Toner Melt-Adhesion Products Generated on Image Bearing Member

As an image forming apparatus, a modified digital printer for commercial printing imageRUNNER ADVANCE C5560 (manufactured by Canon Inc.) was used. The printer was modified to enable free setting of the fixing temperature, process speed, DC voltage V_{DC} of the developer carrier, charging voltage V_{D} of the electrostatic latent image bearing member, and laser power. Further, the evaluation was performed by using an electrostatic latent image bearing member set at a contact angle of 26° and a contact pressure of 0.294 N/cm (30 g/cm) with respect to the surface of the electrostatic latent image bearing member.

In the image output evaluation, an FFh image (solid image) having a desired image ratio was output, and the following evaluation was performed by adjusting V_{DC}, V_{D}, and laser power to obtain the desired toner laid-on level on the FFh image. FFh is a value obtained by displaying 256 gradations in hexadecimal, 00h is the first gradation (white background portion) of 256 gradations, and FFh is the 256th gradation (solid portion) of 256 gradations. As the output image, 100,000 images in which the image area of the solid image was 50% area (A4 paper) were continuously output.

Paper: CS-680 (68.0 g/m²) (Canon Marketing Japan Inc.)

Evaluation image: FFh image on 50 area % of the A4 paper
Vback: 150 V (adjusted by DC voltage V_{DC} of developer carrying member, charging voltage V_{D} of electrostatic latent image bearing member, and laser power)
Test environment: high-temperature and high-humidity environment (temperature 40° C./humidity 80% RH)
Fixing temperature: 180° C.
Process speed: 435 mm/sec
Number of outputs: 100,000

After the continuous printing had been completed, the surface of the electrostatic latent image bearing member was observed with a digital high-definition microscope VQ-7000 (manufactured by KEYENCE) (magnification 300 times). The locations where the toner melt-adhesion products were generated in the visual field were marked, the area thereof was determined, and the ratio of the area where melt adhesion has occurred in the visual field was determined. The observation was performed in 20 fields on the entire surface of the electrostatic latent image bearing member, and the average value was taken as a melt adhesion generation rate. This evaluation was performed three times, and the rank was calculated from the average value. The evaluation ranking was as follows. The evaluation results are shown in Table 3. When the results were A to C, it was evaluated that an effect was exerted.

Evaluation Criteria

A: melt adhesion generation rate is less than 1%
B: melt adhesion generation rate is 1% or more and less than 5%
C: melt adhesion generation rate is 5% or more and less than 10%
D: melt adhesion generation rate is 10% or more

Evaluation of Difference in Density

The evaluation was performed by the following method using a modified digital printer for commercial printing imageRUNNER ADVANCE C5560 (manufactured by Canon Inc.) with the same setting conditions as above. In the image output evaluation, 1000 FFh images (solid images) were continuously output on A4 paper in a vertical band having a width of 3 cm. After that, a difference in density (difference between the segments corresponding to the positions of the vertical band portion and the non-vertical band portion in the previous step) formed on a halftone image when 10 BB images (halftone images) were continuously output on A4 paper with an image area of 100% was verified.

Paper: CS-680 (68.0 g/m²) (Canon Marketing Japan Inc.)

Evaluation image: described hereinabove
Vback: 150 V (adjusted by DC voltage V_{DC} of developer carrying member, charging voltage V_{D} of electrostatic latent image bearing member, and laser power)
Test environment: normal-temperature and low-humidity environment (temperature 23° C./humidity 15% RH)
Fixing temperature: 180° C.
Process speed: 435 mm/sec
Number of outputs: described hereinabove

As for the difference in density on the halftone image, image density was evaluated using a reflection densitometer RD918 (manufactured by Macbeth) and ranked according to the following evaluation criteria. The evaluation results are shown in Table 3. When the results were A to C, it was evaluated that an effect was exerted.

Evaluation Criteria

A: difference in density is less than 0.03
B: difference in density is 0.03 or more and less than 0.05
C: difference in density is 0.05 or more and less than 0.07
D: difference in density is 0.07 or more

Evaluation of Transfer Efficiency

The evaluation was performed under the following paper-passing conditions by using a modified digital printer for commercial printing imageRUNNER ADVANCE C5560 (manufactured by Canon Inc.).

Paper: CS-680 (68.0 g/m²) (Canon Marketing Japan Inc.) Evaluation image: FFh image on 1 area % of the A4 paper

Vback: 150 V (adjusted by DC voltage V_{DC} of developer carrying member, charging voltage V_{D} of electrostatic latent image bearing member, and laser power)
Test environment: high-temperature and high-humidity environment (temperature 30° C./humidity 80% RH)
Fixing temperature: 180° C.
Process speed: 377 mm/sec
Number of outputs: 30,000

After adjusting the development voltage to obtain a toner laid-on level of the image of 0.6 mg/cm², a solid image was output at the initial stage of durability, an image with the abovementioned toner laid-on level was output after 50,000 sheets, the untransferred toner on the electrostatic latent image bearing member at the time of image formation was stripped off by taping with a transparent pressure-sensitive adhesive tape made of a polyester, and a density obtained by subtracting the density in the case of pasting only the pressure-sensitive adhesive tape on paper from the density obtained by pasting the stripped-off pressure-sensitive adhesive tape on paper was calculated. The following determination was made from the values of the density at the initial stage of durability and after the durability of 50,000 sheets. The density was measured with the abovementioned X-Rite color reflection densitometer (500 series).

The evaluation results are shown in Table 3. When the results were A to C, it was evaluated that an effect was exerted.

Evaluation Criteria

A: density change is less than 0.05
B: density difference is 0.05 or more and less than 0.10
C: density difference is 0.10 or more and less than 0.15
D: density difference is 0.15 or more

### Examples 2 to 16 and Comparative Examples 1 to 5

The evaluation was carried out in the same manner as in Example 1 except that the two-component developers 2 to 21 were used. The evaluation results are shown in Table 3.

TABLE 3

| | | Two- | | | |
|---|---|---|---|---|---|
| | | component | Evaluation | | |
| | Toner | developer | | Difference in | Transfer |
| | No. | No. | Cleaning | density | efficiency |
| Example 1 | 1 | 1 | A | A | A |
| Example 2 | 2 | 2 | C | A | C |
| Example 3 | 3 | 3 | A | B | A |
| Example 4 | 4 | 4 | A | A | B |
| Example 5 | 5 | 5 | B | A | A |
| Example 6 | 6 | 6 | B | A | A |
| Example 7 | 7 | 7 | A | A | A |
| Example 8 | 8 | 8 | B | A | B |
| Example 9 | 9 | 9 | B | A | B |
| Example 10 | 10 | 10 | B | A | A |
| Example 11 | 11 | 11 | A | A | B |
| Example 12 | 12 | 12 | A | A | A |
| Example 13 | 13 | 13 | A | B | A |
| Example 14 | 14 | 14 | A | A | A |
| Example 15 | 15 | 15 | A | A | A |
| Example 16 | 16 | 16 | A | B | A |
| Example 17 | 17 | 17 | A | B | A |
| Comparative | 18 | 18 | C | A | D |
| Example 1 | | | | | |
| Comparative | 19 | 19 | D | A | A |
| Example 2 | | | | | |
| Comparative | 20 | 20 | C | D | A |
| Example 3 | | | | | |
| Comparative | 21 | 21 | D | D | A |
| Example 4 | | | | | |
| Comparative | 22 | 22 | D | B | A |
| Example 5 | | | | | |
| Comparative | 23 | 23 | D | B | D |
| Example 6 | | | | | |
| Comparative | 24 | 24 | D | A | D |
| Example 7 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-101439, filed Jun. 11, 2020 which is hereby incorporated by reference herein in its entirety.

What is claimed is:

1. A negative-charging toner comprising:
a toner particle comprising a binder resin; and
an organic-inorganic composite fine particle comprising resin fine particles and inorganic fine particles A, wherein
the organic-inorganic composite fine particle is negative charging;
the organic-inorganic composite fine particle has a structure in which at least a part of the inorganic fine particle A is embedded in the resin fine particle;
a number average particle diameter Db of the organic-inorganic composite fine particle is 50 to 350 nm; and
a plurality of convex portions derived from the inorganic fine particles A are present on the surface of the organic-inorganic composite fine particle.

2. The negative-charging toner according to claim 1, wherein
the resin fine particle comprises a vinyl-based resin,
the vinyl-based resin comprises a monomer unit derived from a vinyl-based monomer comprising a nitrogen atom,
the vinyl-based monomer comprising a nitrogen atom comprises at least one selected from the group consisting of an amino group, an amide group, an imide group, a quaternary ammonium base, a urethane bond, a urea bond, and a nitrogen-containing heterocycle.

3. The negative-charging toner according to claim 2, wherein a content ratio of the monomer unit derived from the vinyl-based monomer comprising a nitrogen atom in the vinyl-based resin is 5 to 30% by mass.

4. The negative-charging toner according to claim 2, wherein the vinyl-based monomer comprising a nitrogen atom comprises at least one monomer selected from the group consisting of aminoethyl methacrylate, aminoethyl acrylate, methacrylamide, acrylamide, N-vinylmaleimide, 4-vinylpyridine, trimethylvinylammonium bromide, N-vinyl-N,N′-trimethylurea, and 2-[[(butylamino) carbonyl]oxy]ethyl acrylate.

5. The negative-charging toner according to claim 1, wherein an amount of the organic-inorganic composite fine particle is 0.1 to 10 parts by mass with respect to 100 parts by mass of the toner particle.

6. The negative-charging toner according to claim 1, wherein the adhesion ratio of the organic-inorganic composite fine particle to the toner particle is 30 to 90% by number.

7. The negative-charging toner according to claim 1, wherein a number average height of the convex portions is 5 to 40 nm.
